(19) United States
(12) Patent Application Publication
(10) Pub. No.: US 2011/0017412 A1
(43) Pub. Date: Jan. 27, 2011

(54) REVERSIBLE SUNSHADE

(76) Inventor: David F. MACNEIL, Hinsdale, IL (US)

Correspondence Address: Momkus McCluskey, LLC, 1001 Warrenville Road, Suite 500, Lisle, IL, 60532, US

(21) Appl. No.: 12/506,363

(22) Filed: Jul. 21, 2009

(51) Int. Cl. E06B 9/24; F16B 47/00

(52) U.S. Cl. 160/370.21; 248/206.2; 296/1.07

(57) ABSTRACT

A reversible sunshade for keeping the interior of a vehicle cool in the summer or heating the interior in the winter has at least one panel with a light-reflective surface and a light-absorbing surface. The sunshade may be attached to the windshield of a vehicle with suction cups that extend through holes in the panel.

### BACKGROUND OF THE INVENTION

It is well known that the interiors of vehicles can become excessively hot on bright, sunny days. The intense heat not only makes it uncomfortable for the person entering the vehicle, but it can age and crack the molded polymer components on the dashboard and bleach the interior of the vehicle. This leads to costly repairs, lowers the resale values, and makes the vehicle less desirable to own over time. Any ultraviolet radiation not filtered out by the coatings on or compositions of the vehicle glass will also cause plastics and rubber to age, crack, and peel. This cause of aging proceeds as a function of incident sunlight rather than temperature.

One common way to lower the temperature in the vehicle interior is to place a sunshade or visor in one or more of the windows to reflect the sunlight out of the vehicle. Conversely, a light absorbing panel may be useful in cold weather conditions for defrosting the windows or as a way of simply warming the interior prior to entering the vehicle, while at the same time shading the dashboard, etc. from ultraviolet light.

While sunshades can be effective, they have thus far been limited by their methods of attachment inside the vehicle. Sunshades are often unwieldy and awkward to put in place and improper placement results in decreased reflection and higher temperatures. Therefore, a need persists for a sunshade that is easy to attach and detach while providing utility in both warm or cold conditions.

### SUMMARY OF THE INVENTION

According to one aspect of the invention, a reversible sunshade for affixation to a transparent window of an enclosure of a vehicle comprises one or more panels having a light-reflecting surface, a light-absorbing surface that is opposite the light-reflecting surface, and an outside margin forming a perimeter of the sunshade. A plurality of fasteners is adaptable to being affixed to the one or more panels at locations interior to the outside margin of the panel.

The sunshade is configurable to be used in either a light reflective mode or a light-absorbing mode. In the light-reflective mode, the fasteners have a first orientation to fasten the light-reflecting surface adjacent the window such that the light reflecting surface reflects light away from the enclosure. In the light-absorbing mode, the fasteners have a second orientation to fasten the light-absorbing surface adjacent the window to absorb incident sunlight.

### BRIEF DESCRIPTION OF THE DRAWINGS

Further aspects of the invention and their advantages can be discerned in the following detailed description, in which like characters denote like parts and in which:

FIGS. 1A and 1B are top and bottom views according to one embodiment of the invention showing a panel with a light-reflective surface and a light-absorbing surface;

FIG. 2 is an isometric view showing an enclosure of a vehicle having a sunshade according to one embodiment of the invention affixed to the windshield in a light-absorbing configuration;

FIG. 3 is an isometric view of a sunshade fastener according to one embodiment of the invention;

FIG. 4A is a side view according to one embodiment of the invention showing a suction cup with an elastic, flexible, enlarged end being inserted through a hole in the sunshade, the sunshade having a light-reflecting surface oriented to be in a light-absorbing mode;

FIG. 4B is a side view according to one embodiment of the invention showing a suction cup with an elastic, flexible, enlarged end being inserted through a hole in the sunshade having a light-absorbing surface oriented to be in a light-reflecting mode; and

FIG. 5 is a side view according to another embodiment of the invention showing a hook and loop fastener for attaching the suction cup to the sunshade.

### DETAILED DESCRIPTION

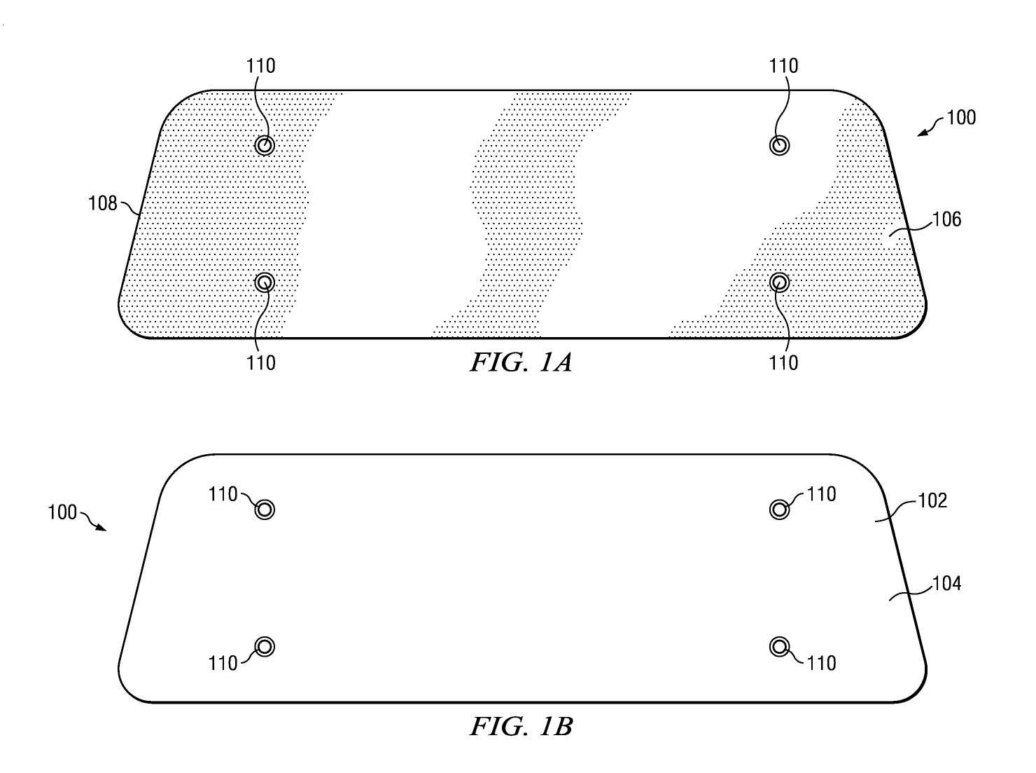

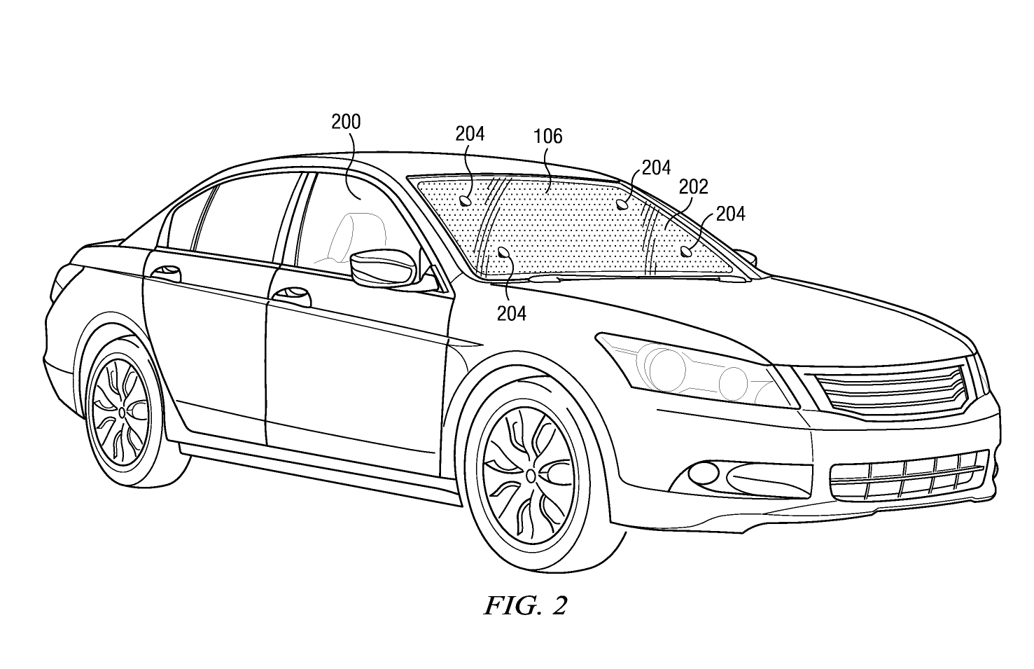

Referring to FIGS. 1A, 1B, and 2, a reversible sunshade, indicated generally at 100, for affixation to a transparent window 202 such as the front windshield of an enclosure 200 of a vehicle, comprises one or more panels 102 having a light-reflecting surface 104 and a light-absorbing surface 106 that is on the reverse side or opposite the light-reflecting surface 104. The sunshade 100 further comprises an outside margin 108 forming a perimeter. The sunshade may be flexible or foldable to facilitate storage or installation.

The sunshade 100 includes a plurality of fasteners 204, such as four such fasteners, that are adaptable to being affixed to the panel 102 at positions that are interior to the outside margin 108 of the panel 102. The sunshade 100 is configurable to either a light reflective mode or a light-absorbing mode. In the light-absorbing mode (FIG. 1A and 4B), the fasteners 204 have a first orientation to fasten the light-absorbing surface 106 adjacent the window 202 to absorb incident sunlight. In the light-reflective mode (FIGS. 1B and 4A), the fasteners 204 having a second orientation to fasten the light-reflecting surface 104 adjacent to the window 202 such that the light reflecting surface 104 reflects light away from the enclosure 200.

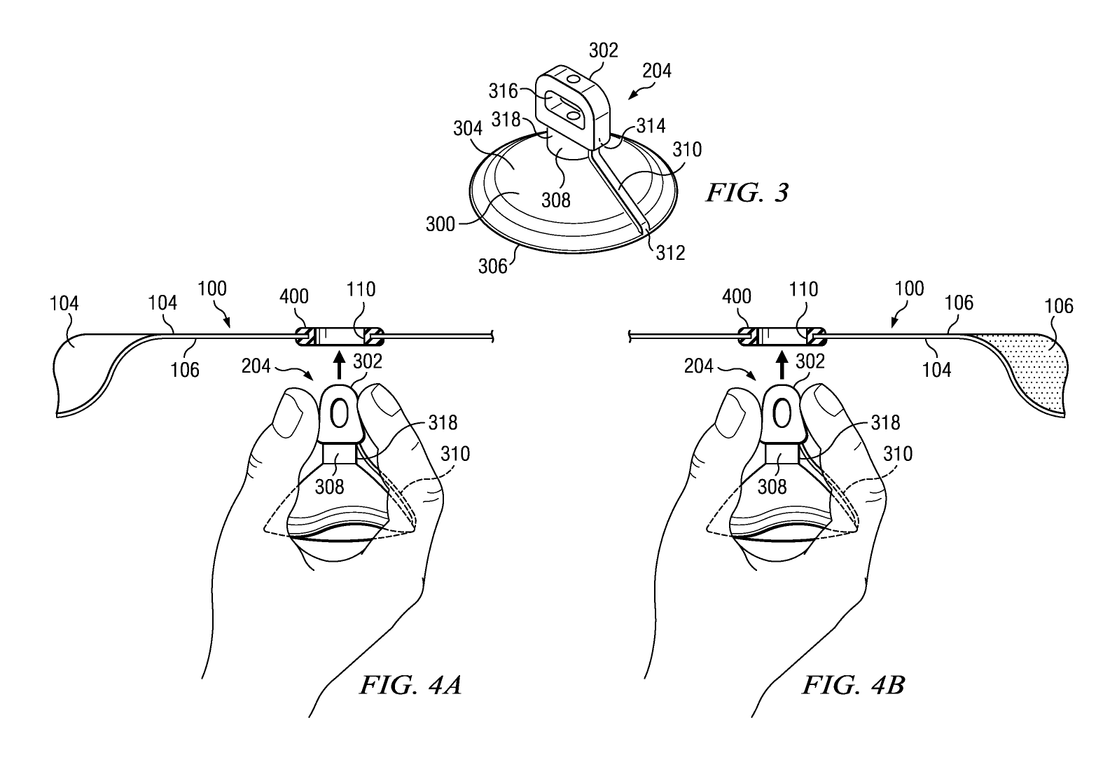

In a preferred embodiment, the one or more panels 102 have a plurality of openings 110 (such as four such openings 110) interior to but near the outside margin 108 of the panel 102. Openings 110 are preferably widely spaced apart from each other and each fastener 204 cooperates with a respective opening 110 in affixing the sunshade to the window 202. As shown in FIG. 3, each fastener 204 has a constriction 318 adjacent to an enlarged, flexible, elastic end 302. FIGS. 4A and 4B show that the elastic end 302 is adaptable to be manually pinched or collapsed and then inserted through either side of a respective opening 110 in the panel 102. The openings may be reinforced by grommets 400.

More preferably, the fasteners 204 include suction cups 300. Each suction cup 300 has a disk body 304 with a rim portion 306 on a lower portion of the disk body 304. The fasteners 204 also have a supporting base 308 formed on an upper portion of said disk body 304, with the enlarged elastic end 302 fixedly mounted on an upper portion of the supporting base 308.

The fastener 204 may also have a drawing strip 310 affixed to the elastic end 302 for detaching the rim portion 306 from the window 202. The drawing strip 310 has a first end portion 312 fixedly attached to the rim portion 306 of the disk body 304 and a second end portion 314 connected to the elastic end 302. Preferably, the elastic end 302 and the supporting base 308 are integrally joined. Additionally, the elastic end 302 may further include an opening 316 to facilitate its deformation. To detach the suction cup 300 from the window 202, the user pulls drawing strip 310 from the other side of grommet 400, lifting an edge 312 of the suction cup 300 and thereby breaking the vacuum that the disk body 304 makes with the window.

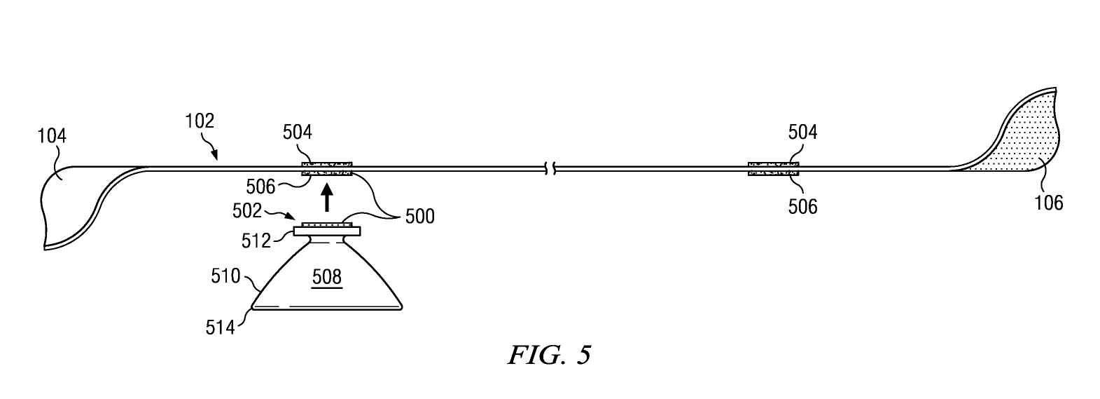

Referring to FIG. 5, the fasteners can, instead, incorporate hook and loop fasteners 500. The term “hook and loop fasteners” as used herein includes fasteners that use dissimilar interlocking elements as well as interlocking elements that are the same. For example, the traditional Velcro® fasteners are an example of dissimilar interlocking elements, while Dual Lock™ fasteners sold by 3M are an example of interlocking elements that are the same. Each fastener 500 comprises a panel attachment surface 502 comprising a selected one of a hook material and a loop material. The light reflecting surface 104 has patches 504 and the light absorbing surface 106 has patches 506 of the other of the hook material and the loop material, with each patch 504, 506 adapted to mate with the panel attachment surface 502 of a respective fastener 500, and with each patch 504 being in registration with a patch 506 but being on the reverse side of the panel 102. Preferably the patches 504, 506 are joined to panel 102 as by means of stitching or gluing.

Again, the hook and loop fasteners 500 may be used in conjunction with a plurality of suction cups 508, with each suction cup 508 having a disk body 510 comprising a rim portion 514 on the lower portion of the disk body 510 and a supporting base 512 formed on an upper portion of the disk body 510. The supporting base 512 of the suction cup 508 may act as the panel attachment surface 502, receiving either the hook material or the loop material. The light-absorbing surface 106 and light-reflecting surface 104 are affixed to the other of the hook material and the loop material.

As above, the panel 102 may be reversed by detaching the panel attachment surface 502 of each suction cup 508 from the either of the respective patches 504, 506 affixed to a given surface of the panel 102, reversing the orientation of the panel 102, and reattaching the other of the respective patches 504, 506 on the opposite surface of the panel 102 to the respective panel attachment surface 502 of each suction cup 508.

In summary, the described embodiments of the invention show an easy-to-use, reversible sunshade that may be used in a light-reflecting mode or a light-absorbing mode to reduce or increase the temperature inside a vehicle as needed.

While illustrated embodiments of the present invention have been described and illustrated in the appended drawings, the present invention is not limited thereto but only by the scope and spirit of the appended claims.

I claim:

1. A reversible sunshade for affixation to a transparent window of an enclosure of a vehicle, the sunshade comprising:
at least one panel having a light-reflecting surface, a light-absorbing surface opposite the light-reflecting surface, and an outside margin forming a perimeter of the sunshade; and
a plurality of fasteners adaptable to being affixed to the panel at respective locations interior to the outside margin of the panel;
wherein the sunshade is configurable to either a light-reflective mode or a light-absorbing mode, the fasteners in the light-absorbing mode having a first orientation to fasten the light-absorbing surface adjacent the window to absorb incident sunlight, and the fasteners in the light-reflective mode having a second orientation to fasten the light-reflecting surface adjacent the window such that the light-reflecting surface reflects light away from the enclosure.

2. The sunshade of claim 1, further comprising a plurality of openings at said respective locations interior to the outside margin of the panel, each fastener cooperating with a respective opening in affixing the sunshade to the window.

3. The sunshade of claim 2, each fastener having a constriction adjacent to an enlarged, flexible, elastic end which is adaptable to be inserted through a respective opening in the panel.

4. The sunshade of claim 3, wherein the fasteners are suction cups.

5. The sunshade of claim 4, each suction cup further comprising a disk body having a rim portion on a lower portion of the disk body, a supporting base formed on an upper portion of said disk body, the elastic end mounted on an upper portion of the supporting base.

6. The sunshade of claim 5, further comprising means on the elastic end for detaching the rim portion from the window.

7. The sunshade of claim 6, wherein the means for detaching the rim portion is a drawing strip having a first end portion fixedly attached to the rim portion of the disk body and a second end portion disposed adjacent to the elastic end, wherein the elastic end and the supporting base are integrally joined.

8. The sunshade of claim 3, wherein the fastener has an opening transversely through its elastic end.

9. The sunshade of claim 2, further comprising a plurality of grommets to reinforce respective ones of the plurality of openings.

10. The sunshade of claim 1, wherein the sunshade is flexible.

11. The sunshade of claim 1, each fastener comprising a panel attachment surface made of a selected one of a hook material and a loop material, the light-reflecting surface having respective patches of the other of the hook material and the loop material, each patch adapted to mate with the panel attachment surface of a respective fastener, the light-absorbing surface having corresponding patches of the other of the hook material and the loop material, each adapted to mate with the panel attachment surface of a respective fastener.

12. The sunshade of claim 11, wherein the fasteners each include a suction cup, each suction cup having a disk body comprising
a rim portion on a lower portion of the disk body; and
a supporting base formed on an upper portion of the disk body;
the supporting base of the suction cup being affixed to the panel attachment surface.
